(19) United States
(12) Patent Application Publication
(10) Pub. No.: US 2013/0201096 A1
(43) Pub. Date: Aug. 8, 2013

(54) DISPLAY METHOD OF AN AUTO-STEREOSCOPIC DISPLAY DEVICE

(71) Applicants: Chih-Yin Chiang, Nantou County (TW); Che-Wei Chang, Taoyuan County (TW)

(72) Inventors: Chih-Yin Chiang, Nantou County (TW); Che-Wei Chang, Taoyuan County (TW)

(21) Appl. No.: 13/545,001

(22) Filed: Jul. 10, 2012

(30) Foreign Application Priority Data
Feb. 7, 2012 (TW) 101103936

(51) Int. Cl. G06F 3/01

(52) U.S. Cl. 345/156

(57) ABSTRACT

An auto-stereoscopic display device includes N pixel groups for displaying N visual angle images respectively, and an optical element for guiding the N visual angle images to corresponding N position groups respectively, a user located at a first to a (N−1)th position groups receives correct visual angle images, a user located at a Nth position group receives wrong visual angle images. A display method of the auto-stereoscopic display device includes the auto-stereoscopic display device displaying the N visual angle images; the auto-stereoscopic display device determining whether a user is located at the Nth position group; and when a user is located at the Nth position group, the auto-stereoscopic display device shifting the N position groups in order to let no user be located at the Nth position group.

### BACKGROUND OF THE INVENTION

1. Field of the Invention

The present invention relates to a display method of a stereoscopic display device, and more particularly, to a display method of an auto-stereoscopic display device.

2. Description of the Prior Art

Please refer to FIG. 1. FIG. 1 is a diagram illustrating an auto-stereoscopic display device displaying stereoscopic images. As shown in FIG. 1, the auto-stereoscopic display device 100 comprises four pixel groups P1, P2, P3, P4 for displaying four visual angle images V1, V2, V3, V4 respectively, and an optical element 110 for guiding the four visual angle images V1, V2, V3, V4 to corresponding four position groups G1, G2, G3, G4 respectively. Wherein a user located at the first position group G1 receives the first visual angle image V1 through a left eye, and receives the second visual angle image V2 through a right eye; a user located at the second position group G2 receives the second visual angle image V2 through a left eye, and receives the third visual angle image V3 through a right eye; a user located at the third position group G3 receives the third visual angle image V3 through a left eye, and receives the fourth visual angle image V4 through a right eye. The first visual angle image V1 is a left visual angle image relative to the second visual angle image V2, the second visual angle image V2 is a left visual angle image relative to the third visual angle image V3, and the third visual angle image V3 is a left visual angle image relative to the fourth visual angle image V4. Therefore, the user located at the first to the third position groups G1, G2, G3 can receive the left and right visual angle images through the left eye and the right eye respectively, such that a stereoscopic effect is generated.

However, a user located at the fourth position group G4 receives the fourth visual angle image V4 through a left eye, and receives the first visual angle image V1 through a right eye. The fourth visual angle image V4 is a right visual angle image relative to the first visual angle image V1. Therefore, the user located at the fourth position group G4 receives wrong visual angle images, such that the stereoscopic effect is not generated.

In order to solve the problem of receiving wrong visual angle images, the auto-stereoscopic display device of the prior art displays more visual angle images to reduce the possibility of receiving wrong visual angle images. However, the method illustrated above will also reduce resolution of each visual angle image, and the user may still possibly receive the wrong visual angle images.

### SUMMARY OF THE INVENTION

The present invention provides a display method of an auto-stereoscopic display device. The auto-stereoscopic display device comprises N pixel groups for displaying N visual angle images respectively, and an optical element for guiding the N visual angle images to corresponding N position groups respectively. A user located at a Kth position group of the N position groups receives a Kth visual angle image through a left eye, and receives a (K+1)th visual angle image through a right eye. The Kth visual angle image is a left visual angle image relative to the (K+1)th visual angle image. A user located at a Nth position group of the N position groups receives an Nth visual angle image through a left eye, and receives a first visual angle image through a right eye. N is an integer greater than 2. K is an integer between 1 and (N−1). The method comprises the auto-stereoscopic display device displaying the N visual angle images; an image capturing module capturing an image in front of the auto-stereoscopic display device; a controller of the auto-stereoscopic display device determining whether a user is located at the Nth position group according to the image captured by the image capturing module; and when the controller of the auto-stereoscopic display device determines that a user is located at the Nth position group, the controller of the auto-stereoscopic display device shifting the N position groups in order to allow no user to be located at the Nth position group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an auto-stereoscopic display device displaying stereoscopic images.

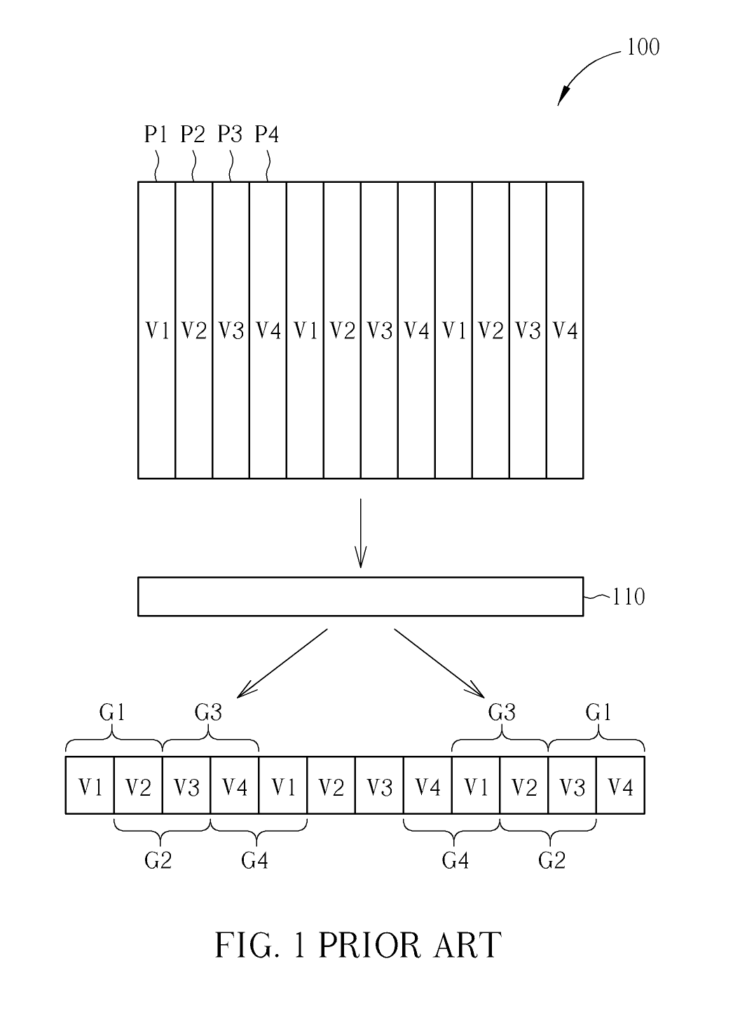

FIG. 2 is a diagram illustrating a first embodiment of an auto-stereoscopic display device of the present invention displaying stereoscopic images.

FIG. 3 is a diagram illustrating a second embodiment of the auto-stereoscopic display device of the present invention displaying stereoscopic images.

FIG. 4 is a diagram illustrating a third embodiment of the auto-stereoscopic display device of the present invention displaying stereoscopic images.

FIG. 5 is a flowchart 500 showing a display method of the auto-stereoscopic display device of the present invention.

### DETAILED DESCRIPTION

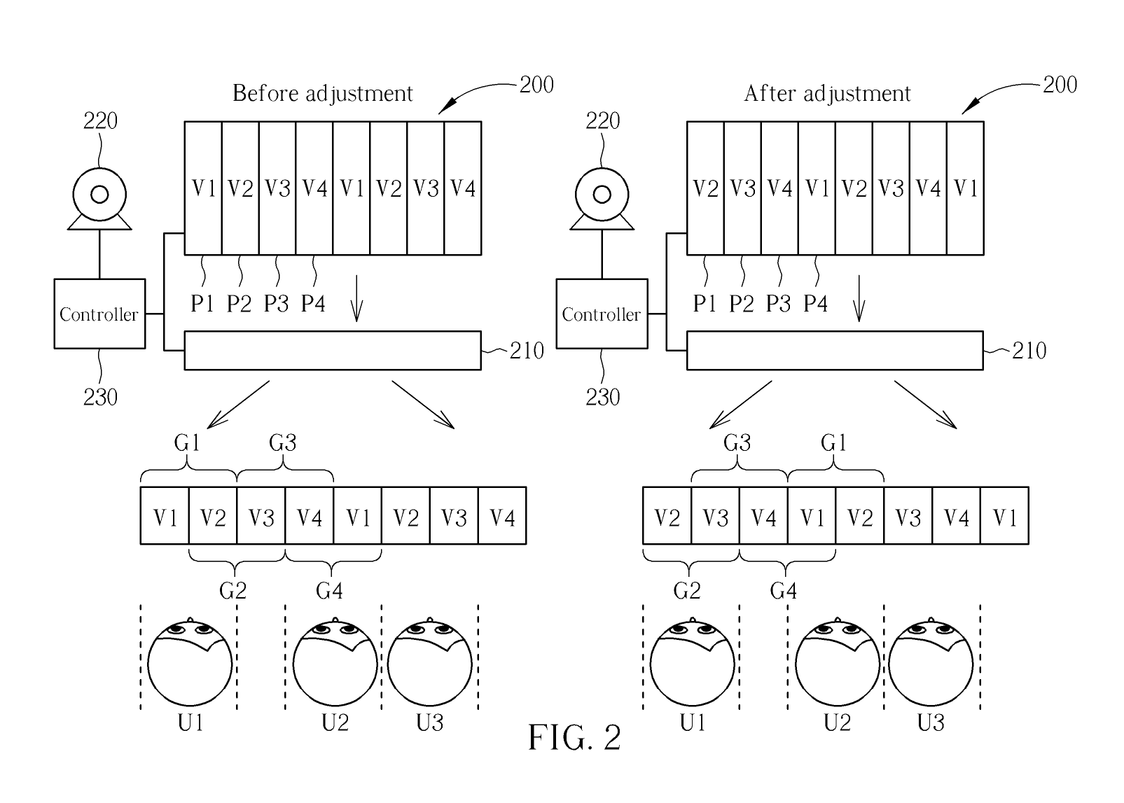

Please refer to FIG. 2. FIG. 2 is a diagram illustrating a first embodiment of an auto-stereoscopic display device of the present invention displaying stereoscopic images. The auto-stereoscopic display device 200 comprises a plurality of pixel groups P1, P2, P3, P4 for displaying a plurality of visual angle images respectively, and an optical element 210 for respectively guiding the plurality of visual angle images to corresponding position groups. For example, the auto-stereoscopic display device is utilized for displaying four visual angle images V1, V2, V3, V4, wherein a user located at a first position group G1 receives the first visual angle image V1 through a left eye, and receives the second visual angle image V2 through a right eye; a user located at a second position group G2 receives the second visual angle image V2 through a left eye, and receives the third visual angle image V3 through a right eye; a user located at a third position group G3 receives the third visual angle image V3 through a left eye, and receives the fourth visual angle image V4 through a right eye; a user located at a fourth position group G4 receives the fourth visual angle image V4 through a left eye, and receives the first visual angle image V1 through a right eye. The first visual angle image V1 is a left visual angle image relative to the second visual angle image V2, the second visual angle image V2 is a left visual angle image relative to the third visual angle image V3, and the third visual angle image V3 is a left visual angle image relative to the fourth visual angle image V4. Therefore, the user located at the first to the third position groups G1, G2, G3 can receive the left and right visual angle images through the left eye and the right eye respectively, such that the stereoscopic effect is generated. However, the user located at the fourth position group G4 receives wrong visual angle images, such that the stereoscopic effect is not generated.

In order to solve the problem of receiving wrong visual angle images, the auto-stereoscopic display device 200 further comprises an image capturing module 220 for capturing an image in front of the auto-stereoscopic display device 200, and determines a position of a user according to an eye-tracking method or a face recognition method. For example, a first user U1 is located at the first position group G1, a second user U2 is located at the fourth position group G4, and a third user U3 is located at the second position group G2. When a controller 230 of the auto-stereoscopic display device 200 determines that the second user U2 is located at the fourth position group G4, the controller 230 of the auto-stereoscopic display device 200 changes the corresponding visual angle images displayed by the four pixel groups P1, P2, P3, P4 according to the position of the user in order to shift the position groups. As shown in FIG. 2, before adjustment, the first pixel group P1 of the auto-stereoscopic display device 200 originally displays the first visual angle image V1, the second pixel group P2 of the auto-stereoscopic display device 200 originally displays the second visual angle image V2, the third pixel group P3 of the auto-stereoscopic display device 200 originally displays the third visual angle image V3, and the fourth pixel group P4 of the auto-stereoscopic display device 200 originally displays the fourth visual angle image V4. After adjustment, the first pixel group P1 of the auto-stereoscopic display device 200 displays the second visual angle image V2, the second pixel group P2 of the auto-stereoscopic display device 200 displays the third visual angle image V3, the third pixel group P3 of the auto-stereoscopic display device 200 displays the fourth visual angle image V4, and the fourth pixel group P4 of the auto-stereoscopic display device 200 displays the first visual angle image V1. Therefore, the four position groups G1, G2, G3, G4 are shifted left in order to allow no user to be located at the fourth position group G4.

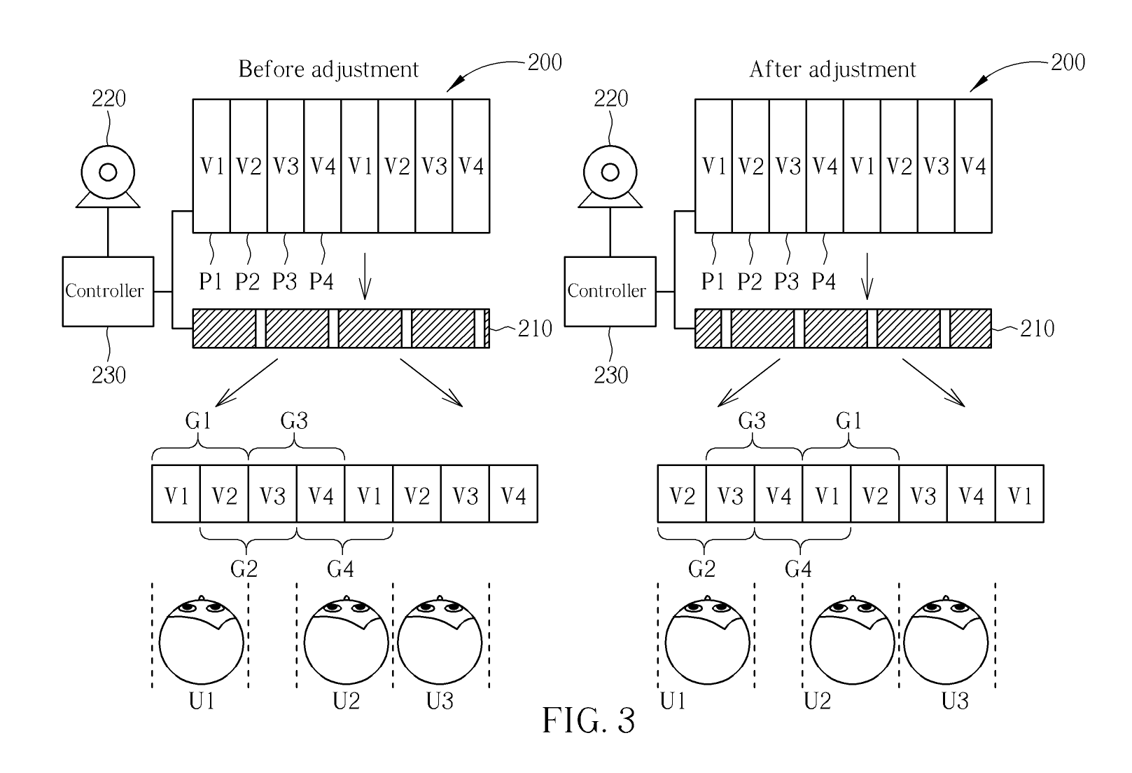

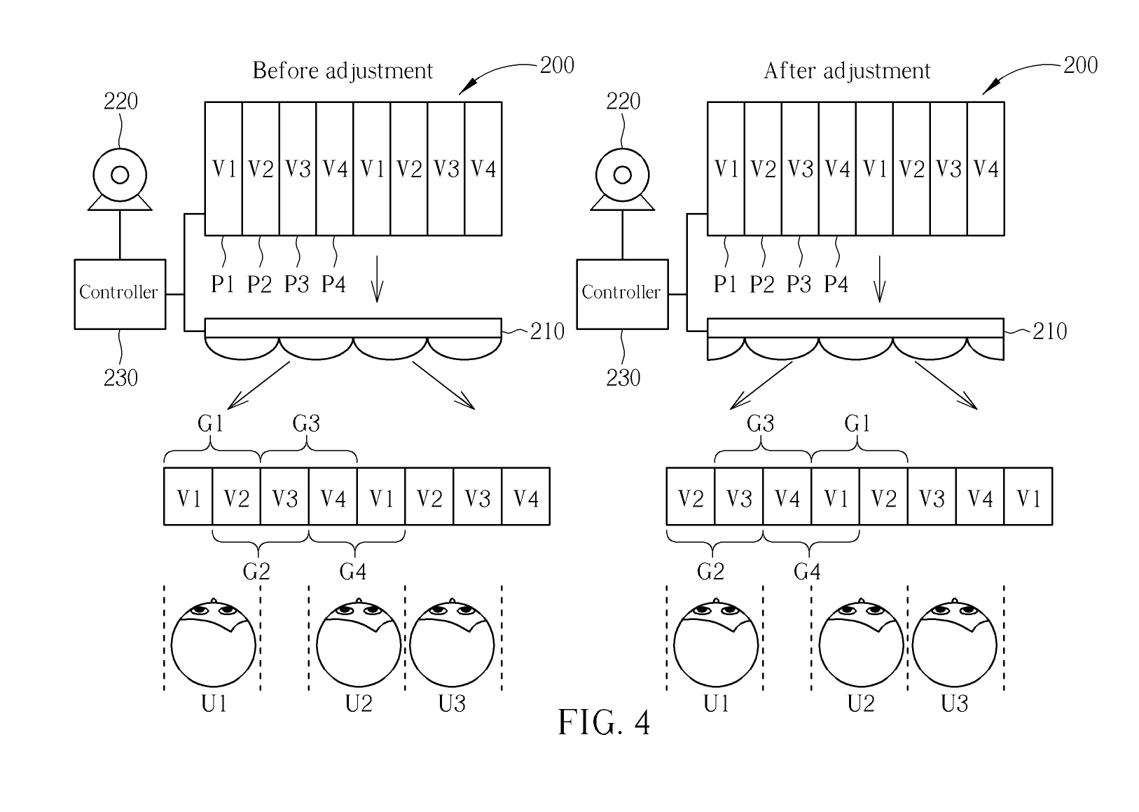

In addition to changing the corresponding visual angle images displayed by the four pixel groups P1, P2, P3, P4 for shifting the position groups G1, G2, G3, G4, the present invention can also control the optical element 210 to shift the position groups G1, G2, G3, G4. For example, please refer to FIG. 3 and FIG. 4. FIG. 3 is a diagram illustrating a second embodiment of the auto-stereoscopic display device of the present invention displaying stereoscopic images. FIG. 4 is a diagram illustrating a third embodiment of the auto-stereoscopic display device of the present invention displaying stereoscopic images. As shown in FIG. 3, the optical element 210 can be a light barrier. The controller 230 of the auto-stereoscopic display device 200 can shift the position groups G1, G2, G3, G4 left by shifting the light barrier 210, in order to allow no user to be located at the fourth position group G4. Alternatively, as shown in FIG. 4, the optical element 210 can be a liquid crystal lens layer. The controller 230 of the auto-stereoscopic display device 200 can shift the position groups G1, G2, G3, G4 left by changing a refraction angle of the liquid crystal lens layer 210, in order to allow no user to be located at the fourth position group G4.

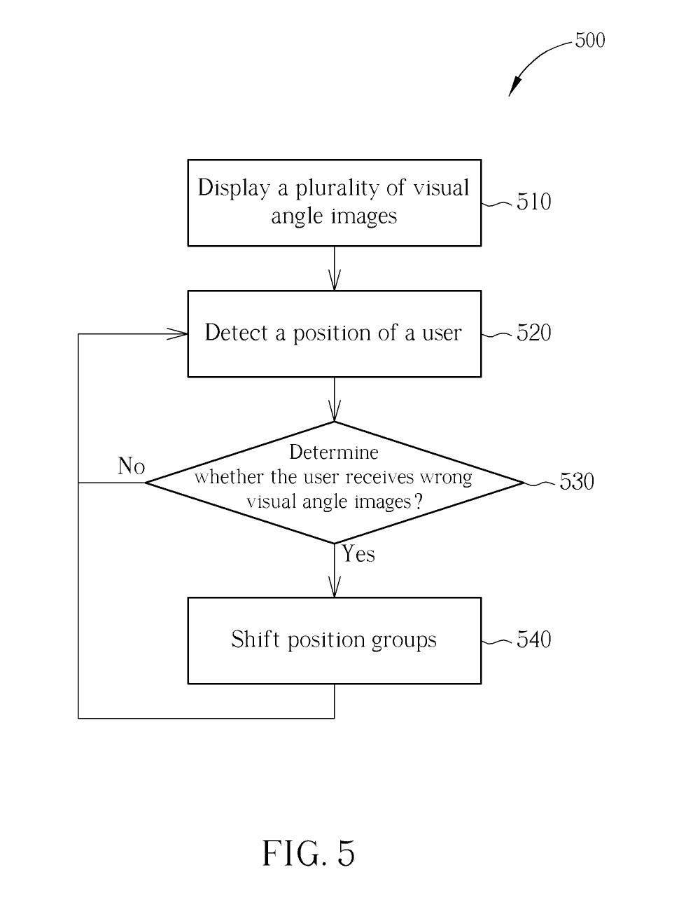

Please refer to FIG. 5. FIG. 5 is a flowchart 500 showing a display method of the auto-stereoscopic display device of the present invention. The display method of the auto-stereoscopic display device of the present invention comprises the following steps:

Step 510: Display a plurality of visual angle images;

Step 520: Detect a position of a user;

Step 530: Determine whether the user receives wrong visual angle images; if yes, go to step 540; if not, go to step 520; and

Step 540: Shift position groups.

Basically, the steps of the flowchart 500 need not be in the exact order shown and need not be contiguous, that is, other steps can be inserted between.

In addition, the number of the visual angle images mentioned above is only for illustrating the embodiments of the present invention. The present invention can be utilized in any auto-stereoscopic display device displaying three or more than three visual angle images. When the present invention is utilized in an auto-stereoscopic display device displaying N visual angle images, at least (N−1) users can receive correct visual angle images.

In contrast to the prior art, the display method of the auto-stereoscopic display device of the present invention can dynamically shift the position groups according to the position of the user, such that the user can receive the correct visual angle images in order to solve the problem of receiving wrong visual angle images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display method of an auto-stereoscopic display device, the auto-stereoscopic display device comprising N pixel groups for displaying N visual angle images respectively, and an optical element for guiding the N visual angle images to corresponding N position groups respectively, a user located at a Kth position group of the N position groups receives a Kth visual angle image through a left eye, and receives a (K+1)th visual angle image through a right eye, the Kth visual angle image is a left visual angle image relative to the (K+1)th visual angle image, a user located at a Nth position group of the N position groups receives an Nth visual angle image through a left eye, and receives a first visual angle image through a right eye, N is an integer greater than 2, K is an integer between 1 and (N−1), the method comprising:
the auto-stereoscopic display device displaying the N visual angle images;
an image capturing module capturing an image in front of the auto-stereoscopic display device;
a controller of the auto-stereoscopic display device determining whether a user is located at the Nth position group according to the image captured by the image capturing module; and
when the controller of the auto-stereoscopic display device determines that a user is located at the Nth position group, the controller of the auto-stereoscopic display device shifting the N position groups in order to allow no user to be located at the Nth position group.

2. The method of claim 1, wherein the controller of the auto-stereoscopic display device shifting the N position groups is the controller of the auto-stereoscopic display device changing the visual angle images corresponding to the N pixel groups in order to shift the N position groups.

3. The method of claim 1, wherein the optical element is a light barrier, the controller of the auto-stereoscopic display device shifting the N position groups is the controller of the auto-stereoscopic display device shifting the light barrier in order to shift the N position groups.

4. The method of claim 1, wherein the optical element is a liquid crystal lens layer, the controller of the auto-stereoscopic display device shifting the N position groups is the controller of the auto-stereoscopic display device changing a refraction angle of the liquid crystal lens layer in order to shift the N position groups.

5. The method of claim 1, wherein the controller of the auto-stereoscopic display device determining whether a user is located at the Nth position group, includes the controller of the auto-stereoscopic display device determining whether a user is located at the Nth position group according to an eye-tracking method.

6. The method of claim 1, wherein the controller of the auto-stereoscopic display device determining whether a user is located at the Nth position group, includes the controller of the auto-stereoscopic display device determining whether a user is located at the Nth position group according to a face recognition method.
